(19) United States
(12) Patent Application Publication
(10) Pub. No.: US 2019/0283133 A1
(43) Pub. Date: Sep. 19, 2019

(54) METHOD FOR PRODUCING PLAIN-BEARING COMPOSITE MATERIALS, PLAIN-BEARING COMPOSITE MATERIAL AND SLIDING ELEMENT COMPRISING PLAIN-BEARING COMPOSITE MATERIALS OF THIS TYPE

(71) Applicant: FEDERAL-MOGUL WIESBADEN GMBH, WIESBADEN (DE)

(72) Inventor: GERD ANDLER, BAD SCHWALBACH (DE)

(73) Assignee: FEDERAL-MOGUL WIESBADEN GMBH, WIESBADEN (DE)

(21) Appl. No.: 16/300,605

(22) PCT Filed: May 11, 2017
(86) PCT No.: PCT/EP2017/061306

§ 371 Date: Nov. 12, 2018

(30) Foreign Application Priority Data
May 18, 2016 (DE) 10 2016 208 485.2

(51) Int. Cl. B22F 3/10; B32B 15/01; B22F 7/00; B22F 7/08; C22C 13/00; C22C 12/00; C22C 21/00; F16C 33/12; F16C 33/14

(52) U.S. Cl. CPC B22F 3/1028; B32B 15/015; B22F 7/008; B22F 7/08; C22C 13/00; C22C 12/00; F16C 2220/20; F16C 33/121; F16C 33/124; F16C 33/145; B22F 2301/10; F16C 2202/04; F16C 2204/10; C22C 21/003

(57) ABSTRACT

A method for producing plain-bearing composite materials (30) includes applying a powder of a bearing metal to a strip material of steel and then sintering the bearing metal. The composite material (25) consisting of the strip material (6) and the bearing metal (14) subsequently undergoes a heat treatment. After the sintering process the composite material (25) is quenched, directly followed by an ageing process. The plain-bearing composite material (30) has a substrate (32) consisting of steel and a sintered bearing metal layer (34) consisting of a copper alloy, the bearing metal layer (34) having a hardness of 100 HBW 1/5/30 to 200 HBW 1/5/30.

The invention relates to a method for producing plain-bearing composite materials, in which a powder of a bearing metal is applied to a strip material made of steel, the bearing metal undergoes at least one sintering process, and the composite material consisting of the strip material and the bearing metal subsequently undergoes heat treatment. The invention also relates to plain-bearing composite materials and to sliding elements comprising plain-bearing composite materials of this type.

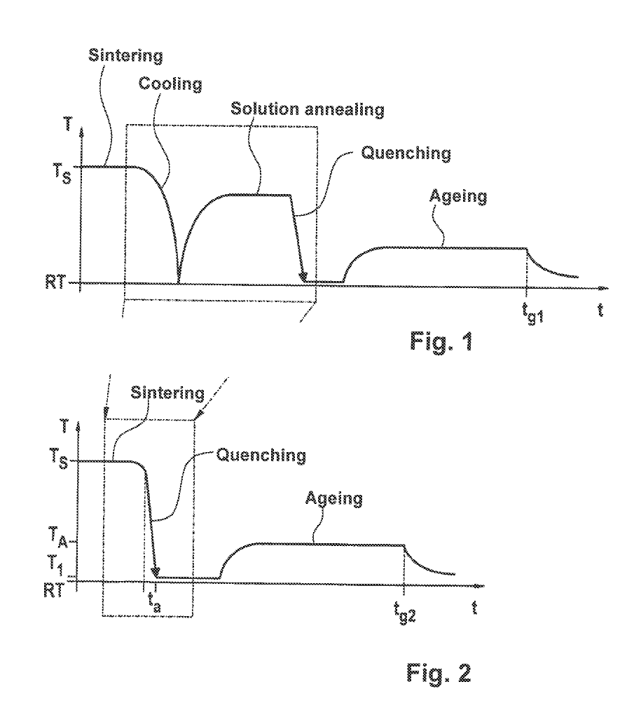

Plain-bearing composite materials have been produced up to now in a manner in which, following sintering of the bearing metal, the composite material is cooled to room temperature and subsequently undergoes heat treatment consisting of an annealing step, quenching to room temperature, and then precipitation hardening (ageing). This procedure is shown schematically in FIG. 1, the temperature T of the individual method steps being plotted against the time t, and is described for example in DE 496 935. RT denotes room temperature (20° C.) and Tₛ denotes the sintering temperature.

The annealing step is also referred to as solution annealing which, according to DIN 17014, means annealing in order to dissolve precipitated components in solid solutions. In the case of austenitic steels, for example, specific precipitable alloy elements are dissolved in y-solid solution. The subsequent, sufficiently rapid, cooling results in a supersaturated y-solid solution that can be hardened.

In addition to the annealing temperature, the dwell time and the cooling speed are important for the grain size achieved after the annealing treatment. Very slow cooling, e.g. in the furnace, causes the conversion of the y-phase to occur at a relatively high temperature. However, the number of nuclei formed per time unit is small, whereas the crystallisation speed is very quick. This meets the requirements for a coarser grain. Rapid cooling results in a finer structure because the conversion does not take place until lower temperatures. Alloying additions may prevent grain growth by forming precipitations (see BARTHOLOME E. 1982 Ullmanns Encyklopädie der technischen Chemie, Vol 22, 4^{th} edition, page 28, Verlag Chemie, Weinheim).

In the case of alloys, solution annealing is also referred to as homogenisation annealing.

Since almost all technical alloys consist entirely or significantly of solid solutions, more or less significantly pronounced crystal segregation often has to be anticipated in the case of cast metals and alloys. However, since a structure that is as uniform as possible is always desired in an alloy, it is expedient to try to eliminate said crystal segregation. This is achieved by means of the homogenisation annealing. The inhomogeneous, segregated alloy is annealed, at temperatures that are as high as possible, until the concentration differences between the crystal edge and the core have equalised by means of diffusion (see SCHUMANN H. 1989, Metallographie [Meltallography], 13^{th} edition, page 376, Deutscher Verlag für Grundstoffindustrie, Leipzig).

Ageing means holding at room temperature (cold ageing) or holding at a higher temperature (hot ageing) in order to bring about demixing and/or precipitation from supersaturated solid solutions. When the supersaturated solid solution becomes depleted, precipitations may occur that take place uniformly (continuously) or non-uniformly (discontinuously).

Precipitation processes of this kind have an important role for example when tempering hardened steel, since martensite is a supersaturated solid solution and carbide may sometimes also precipitate. In the case of steels that contain alloy elements that form special carbides, the carbides of said elements are precipitated out of the martensite at tempering temperatures of 450° C. to 650° C. and bring about secondary hardening (see BARTHOLOMÉ E. 1982 Ullmanns Encyklopädie der technischen Chemie. Vol 22, 4^{th} edition, page 34, Verlag Chemie, Weinheim).

Some copper alloys are hardenable. The hardenability of a copper alloy necessitates the fulfillment of three prerequisites. The alloy components must have a limited degree of solubility when solid, the solubility must reduce as the temperature drops, and the inertia of the equilibrium establishment must be high enough for the solid solution, which is homogenous at a high temperature, to be retained in the solid state following quenching (see DKI, Wärmebehandlung von Kupferwerkstoffen, https://www.kupferinstitut.de/de/werkstoffetverarbeitung/waermebehandung.htm).

DE 10 2005 063 324 B4 discloses a conventional method for producing a plain-bearing composite material, in particular for plain-bearing elements such as plain bearing shells. Said method proposes the following method steps:
applying a copper alloy to a steel substrate layer in order to produce a composite,
sintering the composite, a first annealing process being integrated in the sintering process,
thermomechanical treatment comprising the following steps:
at least one first process of rolling the composite, a degree of deformation of 20 to 30% being implemented,
at least one second annealing process at 500° C. to 600° C. for over an hour.

The first annealing process is homogenisation annealing, and the second annealing process is recrystallisation annealing. Ageing does not take place in this method.

However, a composite material produced in this manner does not meet the increased requirements regarding the strength of plain bearings. The term “strength” combines the terms “tensile strength”, “yield strength” and “elongation at break”.

The object of the invention is therefore that of specifying a production method for plain-bearing composite materials, which method can be carried out more quickly and more cost-effectively and at the same time results in a plain-bearing composite material that has improved mechanical properties, in particular higher strength and increased hardness.

The object of the invention is furthermore that of specifying a corresponding plain-bearing composite material and a plain-bearing element produced therefrom.

This object is achieved by a method having the features of claim 1.

The method is characterised in that the composite material is quenched after the bearing metal has been sintered, and an ageing process subsequently follows.

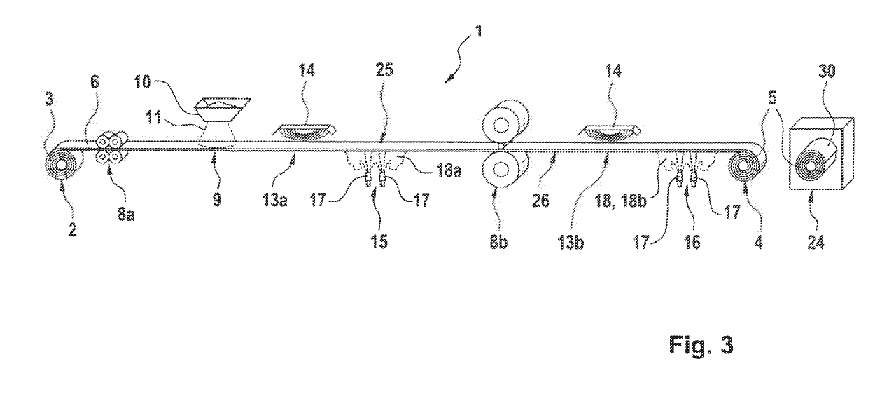

“Subsequently” does not only mean “immediately afterwards”, but rather also includes ageing at a later point in time, e.g. after the composite material has been wound in a top hat furnace, as is described in connection with FIG. 3.

The heat treatment that follows the sintering thus comprises quenching of the composite material and the ageing process, also referred to as ageing.

Quenching means rapid cooling from the sintering temperature to a specified temperature. A quenching process of this kind preferably lasts for less than two minutes, particularly preferably less than one minute.

Between the sintering and the ageing process, the method is carried out without an annealing step.

Omitting the annealing step shortens the production method in terms of time. Energy and costs for heating the composite material in order to carry out the annealing step are also saved.

It has furthermore been found that the mechanical properties of the composite material can be significantly improved by the combination of sintering, the quenching process, and subsequent ageing.

On account of the sintering of the bearing metal powder and the subsequent quenching, the steel undergoes heat treatment that is similar to heat treatment for hardening steel. The typical sintering temperatures for bearing metals, in particular consisting of copper alloys, are between 800° C. and 1100° C. which corresponds to the annealing temperature range of between 1000° C. and 1100° C. that is typically used for hardening austenitic steels.

The hardness of the steel can be set within the range of from 150 HBW 1/5/30 to 250 HBW 1/5/30.

The advantage of the method according to the invention is therefore that the sintering, in combination with the process of quenching the sintering layer, is used for hardening the steel.

Quenching the bearing metal sintering layer has the further advantage that the bearing metal structure forming is frozen in the state of a supersaturated solid solution.

The frozen supersaturated solid solution as the starting structure for the ageing has the advantage that for example the hardness of the bearing metal can be set in a targeted manner within a wide range by means of an appropriate selection of temperature and time duration for the heat treatment. This also applies to other mechanical properties such as the tensile strength, the yield strength and the elongation at break, as well as for the electrical conductivity, which is closely linked to the thermal conductivity.

It has been found that a temperature range of from preferably 350° C. to preferably 520° C. and a time duration of from four hours to ten hours is preferred for the ageing process in order to set the mechanical properties in a targeted manner. In this case, the long time durations are preferably combined with the low ageing temperatures and vice versa.

With respect to the bearing metal, the hardness can be set so as be in the range of from 100 to 200 HBW 1/5/30 and the electrical conductivity can be set so as to be in the range of from 20 to 50% IACS. IACS stands for “International Annealed Copper Standard”. In this case, the electrical conductivity is expressed as a percentage of the electrical conductivity in pure annealed copper. 100% IACS corresponds to an electrical conductivity of 58·10⁵ S/m. Values of between 380 MPa and 500 MPa can preferably be set for the tensile strength, values of 250 to 450 MPa can preferably be set for the yield strength, and values of 5 to 35% can preferably be set for the elongation at break.

The ageing process is preferably carried out at a temperature of between 350° C. and 420° C. The ageing in this temperature range results in only a small increase in hardness of the bearing metal compared with the sintering state, the achievable hardness substantially corresponding to the hardness that is comparable with the conventional method comprising solution annealing.

However, this measure allows for a significant increase in the yield strength of the bearing metal compared with the prior art. The plain-bearing composite material is therefore very suitable for heavy-duty applications, for example in heavy lorries, construction vehicles or other heavy utility vehicles and work machines in which said plain-bearing composite material is used for sliding elements such as plain bearing shells, plain bearing bushings or sliding segments.

The ageing process is preferably carried out at a temperature of between >420° C. and 520° C. The advantage of ageing in this temperature range is that the hardness, the tensile strength and the yield strength of the bearing metal can be significantly increased and set in a targeted manner, compared with the prior art. The plain-bearing composite material is therefore very suitable for use in industry, for example in valve plates of hydraulic pumps.

The ageing process does not have any influence on the hardness of the steel already achieved by the quenching, and therefore the parameters of the ageing process, such as temperature and holding time, can be selected exclusively for setting the properties of the bearing metal.

The method is advantageous in that a composite material can be produced which comprises a very hard steel in combination with bearing metal layers of different hardnesses.

An austenitic steel is preferably used as the steel, a steel having a carbon content of from 0.15 wt. % to 0.40 wt. % particularly preferably being used. Steels, by way of example, and the composition thereof can be found in Table 1, below.

TABLE 1

| Steel grade | | Chemical composition (percentage by mass) | | | | | | | | |
|---|---|---|---|---|---|---|---|---|---|---|
| | Material | | Si | | P | | Cr | Mo | Ni | Cr + Mo + |
| Short form | numbers | C | max. | Mn | max. | S | max. | max. | max. | Ni max. |

High-grade steels

| | | | | | | | | | | |
|---|---|---|---|---|---|---|---|---|---|---|
| C35 | 1.0501 | 0.32 to | 0.40 | 0.50 to | 0.045 | max. | 0.40 | 0.10 | 0.40 | 0.63 |
| | | 0.39 | | 0.80 | | 0.045 | | | | |
| C40 | 1.0511 | 0.37 to | 0.40 | 0.50 to | 0.045 | max. | 0.40 | 0.10 | 0.40 | 0.63 |
| | | 0.44 | | 0.80 | | 0.045 | | | | |

Stainless steels

| | | | | | | | | | | |
|---|---|---|---|---|---|---|---|---|---|---|
| C22 E | 1.1151 | 0.17 to | 0.40 | 0.40 to | 0.030 | max. | 0.40 | 0.10 | 0.40 | 0.63 |
| | | 0.24 | | 0.70 | | 0.035 | | | | |
| C22 P | 1.1149 | | | | | 0.020 to | | | | |
| | | | | | | 0.040 | | | | |

In these steels, the austenitic phase of the steel is frozen by the quenching process.

A bearing metal consisting of a powder of a copper alloy is preferably applied. It has been found that the mechanical properties of the bearing metal can be set within a wide range if a copper alloy, preferably a hardenable copper alloy, in particular a copper-nickel alloy, a copper-iron alloy, a copper-chromium alloy or a copper-zircon alloy is used as the bearing metal.

The compositions of preferred copper alloys are summarised in Table 2.

TABLE 2

| | EN | UNS | | | | | | | | | | | TC | |
|---|---|---|---|---|---|---|---|---|---|---|---|---|---|---|
| | number | number | Cu | Cr | Zr | Ni | Si | Fe | P | Mn | Zn | other | W/(mK) | State |
| CuCr1Zr | CW106C | C18150 | remain- | 0.5-1.2 | 0.03-0.3 | | max. | max. | | | | max. | 320 | hard- |
| | | | der | | | | 0.1 | 0.08 | | | | 0.2 | | ened |
| CuCr1 | CW105C | C18200 | remain- | 0.3-1.2 | | | | | | | | | 325 | |
| | | | der | | | | | | | | | | | |
| CuFe2P | CW107C | C19400 | remain- | | | | | 2.1-2.6 | 0.015-0.15 | | 0.05-0.2 | | 260 | |
| | | | der | | | | | | | | | | | |
| CuNi1P | CW108C | C19000 | remain- | | | 0.8-1.2 | | | 0.15-0.25 | | | max. | 251 | hard- |
| | | | der | | | | | | | | | 0.1 | | ened |
| CuNi1Si | CW109C | C19010 | remain- | | | 1.0-1.6 | 0.4-0.7 | max. | | max. | | max. | 150-250 | hard- |
| | | | der | | | | | 0.2 | | 0.1 | | 0.3 | | ened |
| CuNi2Si | CW111C | C70260 | remain- | | | 1.6-2.5 | 0.4-0.8 | max. | | max. | | max. | 160 | |
| | | | der | | | | | 0.2 | | 0.1 | | 0.3 | | |
| CuNi3Si | CW112C | C70250 | remain- | | | 2.6-4.5 | 0.8-1.3 | max. | | max. | | max. | 190 | |
| | | | der | | | | | 0.2 | | 0.1 | | 0.5 | | |
| CuNi2Si | CS-4 | | remain- | | | 1.5-2.5 | 0.4-0.8 | max. | | | | max. | | |
| | | | der | | | | | 0.7 | | | | 0.5 | | |
| CuZr | CW120C | C15000 | remain- | | 0.1-0.2 | | | | | | | max. | 310-330 | |
| | | | der | | | | | | | | | 0.1 | | |

EN means the material number according to the European standard, and UNS means the material number according to the American standard (ASTM).

The quenching process is preferably started immediately after the sintering process. This prevents normal, i.e. uncontrolled, cooling from starting after the sintering process, which would have the disadvantage that the bearing metal structure would too closely approach the state of equilibrium, rendering precipitation hardening, intended immediately following the sinter-fusing, more difficult or impossible.

The quenching process preferably begins within 15-25 seconds following the sintering process.

The composite material is preferably quenched to a temperature T₁ of from 150° C. to 250° C. The further cooling to room temperature takes place passively by the material being left to cool. The cooling can also take place when the composite material is in the wound state.

The quenching process is preferably carried out at a quenching rate of 10 K/s-30 K/s. In the case of a quenching rate lower than 10 K/s, it is not possible to ensure that the bearing metal is present in a supersaturated solid solution state, making precipitation hardening more difficult or impossible.

A quenching rate higher than 30 K/s is not required because it has been found in tests that quenching rates of >30 K/s do not bring about any further advantage with regard to the precipitation effect.

The quenching rate should preferably be adjusted to the alloy in question. It is preferable for quenching of the copper-nickel alloy to be carried out at a quenching rate of 15 K/s to 25 K/s.

It is preferable for the quenching of the copper-iron alloy to be carried out at a quenching rate of 15 K/s to 25 K/s.

It is preferable for the quenching of the copper-chromium alloy to be carried out at a quenching rate of 10 K/s to 20 K/s.

It is preferable for the quenching of the copper-zircon alloy to be carried out at a quenching rate of 10 K/s to 25 K/s.

The different quenching rates for the individual copper alloys are necessary because the two-phase region, consisting of the α-solid solution and the hard particles, extends over temperature ranges of different sizes, depending on the alloy system. Therefore, a higher cooling speed has to be achieved for alloy systems having a wide two-phase region, in order to generate as little precipitation as possible during the sintering process, than is the case for the systems having a narrower two-phase region.

The quenching of the composite material following the sintering can be achieved by a combination of quenching using water and what is known as a jet cooler. In a jet cooler, for example a piezo element such as bellows, operates such that a gas jet is expelled at high speed.

A nitrogen-hydrogen mixture is blown onto the composite material at high speed, preferably after said material has passed through a water bath, and said material is thus cooled rapidly. It is also possible for the complete quenching to be achieved only using a jet cooler if gas mixtures having a high hydrogen content of up to 50% are used. Increasing the hydrogen content in the gas mixture makes it possible to significantly increase the thermal conductivity of the gas mixture.

The rear face of the composite material is preferably sprayed with the quenching medium. Spraying the steel rear face of the strip material ensures that the steel is first quenched and only then is the bearing metal cooled. This ensures that the desired hardness of the steel is achieved in any case, especially since the hardness of the bearing metal is in any case set only by the subsequent ageing process.

When producing the plain-bearing composite material, a strip of steel is preferably unwound from a roll and fed continuously to the individual treatment stations that are arranged one behind the other. The finished plain-bearing composite material is wound up again at the end of the production process and subsequently fed to a separate ageing station.

The plain-bearing composite material is further processed, subsequently or at a later point in time, into plain-bearing elements such as plain bearing half-shells, plain bearing plates etc. During the further processing, further layers, in particular a sliding layer, are applied if required.

The sintering process is preferably carried out at a temperature Tₛ₁ of from 920° C. to 980° C. for a time duration of from 6 minutes to 12 minutes.

If two sintering processes are preferably carried out, the second sintering process is carried out at a temperature Tₛ₂ of from 900° C. to 950° C. for a time duration of from 6 minutes to 12 minutes.

A cooling step having a cooling speed in the range of from 5 K/s to 15 K/s is preferably carried out between the first sintering process and the second sintering process.

Furthermore, a rolling step for compressing the bearing metal layer may be provided between the two sintering processes. Said rolling step is preferably carried at degrees of deformation of 15-35%.

The plain-bearing composite material comprises a steel substrate layer and a sintered bearing metal layer consisting of a copper alloy, and is characterised in that the bearing metal layer has a hardness of from 100 HBW 1/5/30 to 200 HBW 1/5/30.

The substrate layer preferably has a hardness of from 150 HBW 1/5/30 to 250 HBW 1/5/30.

The substrate layer preferably has a hardness of from 190 to 210 HBW 1/5/30.

The bearing metal layer preferably has a hardness of from 100 to 180 HBW 1/5/30.

The bearing metal layer preferably has a tensile strength of from 380 MPa to 500 MPa, particularly preferably of from 390 to 480 MPa.

The yield strength of the bearing metal layer is preferably between 250 MPa and 450 MPa.

The elongation at break of the bearing metal layer is preferably between 5% and 35%.

The copper alloy is preferably a copper-nickel alloy, a copper-iron alloy, a copper-chromium alloy or a copper-zircon alloy.

The alloy content of nickel is preferably in the range of from 0.5 to 5 wt. %, particularly preferably in the range of from 1 to 3 wt. %.

The alloy content of iron is preferably in the range of from 1.5 to 3 wt. %, particularly preferably in the range of from 1.9 to 2.8 wt. %.

The alloy content of chromium is preferably in the range of from 0.2 to 1.5 wt. %, particularly preferably in the range of from 0.3 to 1.2 wt. %.

The alloy content of zircon is preferably in the range of from 0.02 to 0.5 wt. %, particularly preferably in the range of from 0.3 to 0.5 wt. %.

The alloy content of phosphorous is preferably in the range of from 0.01 to 0.3 wt. %, the content of manganese is preferably in the range of from 0.01 to 0.1 wt. %, and the content of zinc is preferably in the range of from 0.05 to 0.2 wt. %.

The plain-bearing element according to the invention comprises the plain-bearing composite material according to the invention and preferably a sliding layer that is applied to the bearing metal layer.

It is furthermore advantageous for the sliding layer to consist of a galvanic layer. Galvanic layers are multifunctional materials that are characterised, inter alia, by good embeddability for foreign particles, by run-in properties or adjustment to the sliding partner, as protection against corrosion, and by good emergency operating features in the event of a lack of oil. Galvanic layers are advantageous in particular when using low-viscosity oils, because mixed friction states may arise more frequently in this case, in which states the mentioned properties become important.

The galvanic layer preferably consists of a tin-copper alloy, a bismuth-copper alloy or pure bismuth.

In the tin-copper alloys the copper content is preferably 1-10 wt. %. In the bismuth-copper alloys the preferred copper content is 1-20 wt. %.

A further preferred method is the PVD method, and in this case in particular sputtering. Sputter layers preferably consist of aluminium-tin alloys, aluminium-tin-copper alloys, aluminium-tin-nickel-manganese alloys, aluminium-tin-silicon alloys or aluminium-tin-silicon-copper alloys.

In said alloys, the tin content is preferably 8-40 wt. %, the copper content 0.5-4.0 wt. %, the silicon content 0.02-5.0 wt. %, the nickel content 0.02-2.0 wt. %, and the manganese content 0.02-2.5 wt. %.

According to a further embodiment, the sliding layer may consist of a plastics layer. Plastics layers are preferably applied using a finishing or printing method, such as screen or pad printing, by means of dipping or spraying.

For this purpose, the surface to be coated must be appropriately prepared by means of degreasing, chemical or physical activation, and/or mechanical roughening, for example by sand blasting or grinding.

The matrix of the plastics layers preferably consists of high-temperature-resistant resins such as PAI. Furthermore, additives such as MoS₂, boron nitride, graphite or PTFE may be embedded in the matrix. The content of the additives, individually or in combination, is preferably between 5 and 50 vol. %.

Examples of galvanic sliding layers are summarised in Table 3.

TABLE 3
(figures in wt. %)

| Example | 4 | 5 | 6 |
|---|---|---|---|
| Tin | 94 | | |
| Bismuth | | 100 | 95 |
| Copper | 6 | | 5 |

A preferred galvanic sliding layer comprises a tin matrix in which tin-copper particles are embedded that consist of 39-55 wt. % copper and the remainder tin. The particle diameters are preferably between 0.5 μm and 3 μm.

The galvanic layer is preferably applied to an intermediate layer, in particular to two intermediate layers, the first intermediate layer consisting of Ni and the second intermediate layer located thereabove consisting of nickel and tin. The NI content of the second intermediate layer is preferably 30-40 wt. % Ni. The first intermediate layer preferably has a thickness of from 1 to 4 μm and the second intermediate layer preferably has a thickness of from 2 to 7 μm.

Examples for sputter layers are summarised in Table 4.

TABLE 4
(figures in wt. %)

| Example | 7 | 8 | 9 | 10 | 11 |
|---|---|---|---|---|---|
| Al | remainder | remainder | remainder | remainder | remainder |
| Sn | 22 | 35 | 25 | 10 | 20 |
| Cu | 0.7 | 1.2 | 0.7 | 0.5 | 0.5 |
| Si | | | 2.5 | | 1.5 |
| Mn | | | | 1.5 | |
| Ni | | | | 0.7 | 0.7 |

Examples for plastics sliding layers are summarised in Table 5.

TABLE 5
(figures in vol. %)

| Example | 12 | 13 | 14 | 15 | 16 |
|---|---|---|---|---|---|
| PAI | 70 | 80 | 70 | 75 | 65 |
| MoS₂ | 30 | | | | 20 |
| BN | | 20 | | | |
| Graphite | | | 30 | | |
| PTFE | | | | 25 | 15 |

All the sliding layers mentioned may be combined with the bearing metal layers consisting of the copper alloys.

The plain bearing element is preferably designed as a plain bearing shell, as a valve plate, or as a sliding segment, for example a sliding guide rail.

Exemplary embodiments will be explained in greater detail in the following, with reference to the drawings, in which:

FIG. 1 schematically shows the production method according to the prior art,

FIG. 2 schematically shows the procedure according to the invention,

FIG. 3 schematically shows a conveyor system according to the invention,

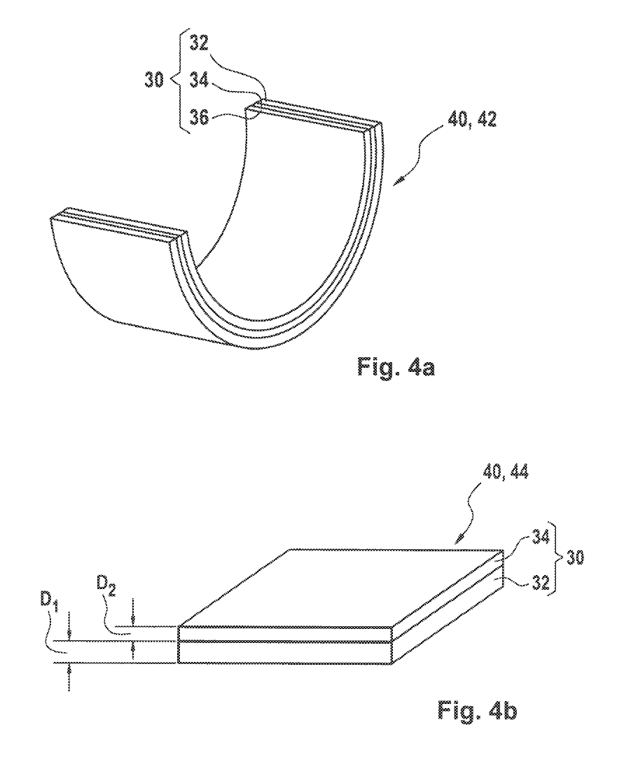

FIGS. 4a and b are perspective views of two sliding elements,

FIG. 5 is a graph showing the hardness as a function of the structural state, for a comparative example,

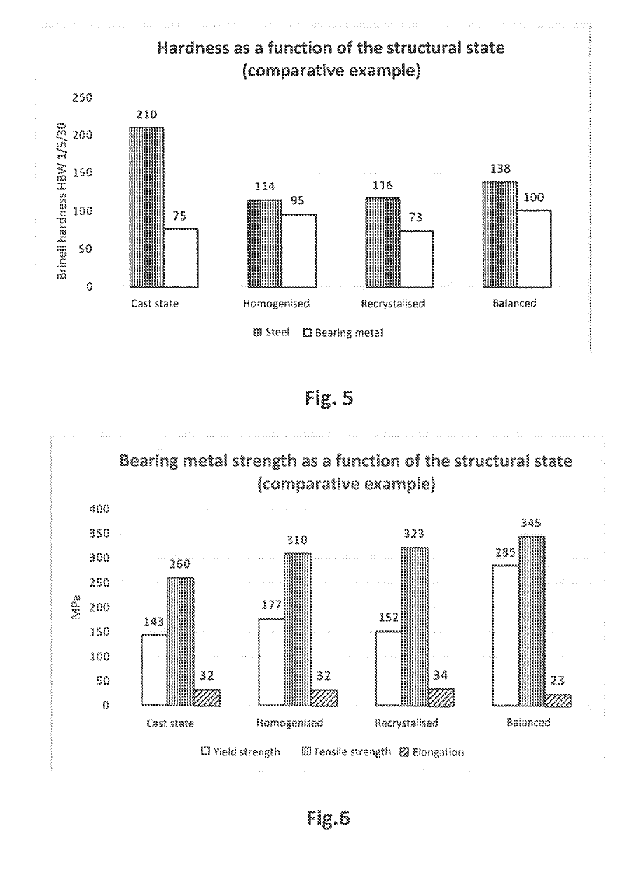

FIG. 6 is a graph showing the bearing metal strength as a function of the structural state, for the comparative example,

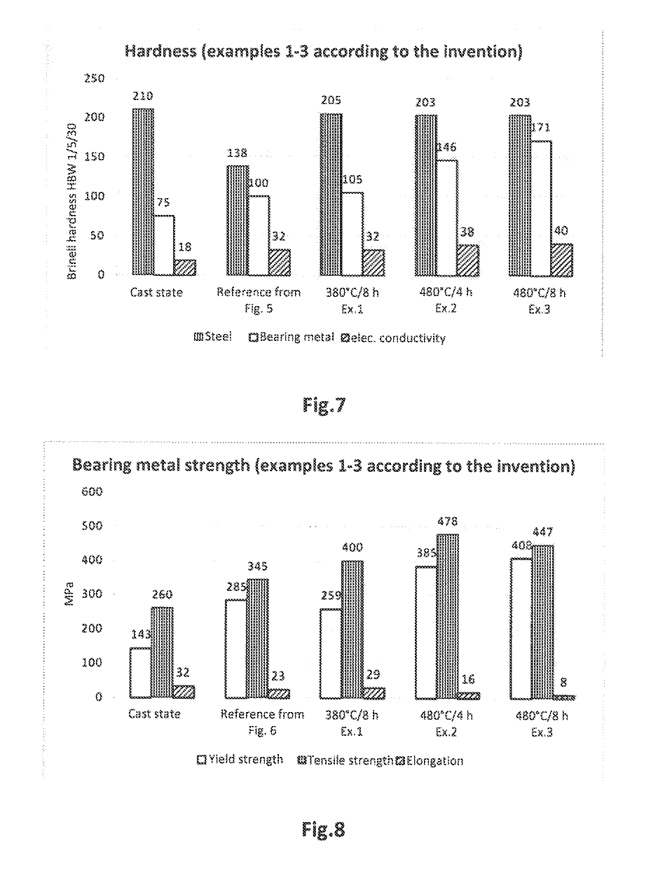

FIG. 7 is a graph showing the hardness for examples 1 to 3 according to the invention,

FIG. 8 is a graph showing the bearing metal strength for examples 1 to 3 according to the invention.

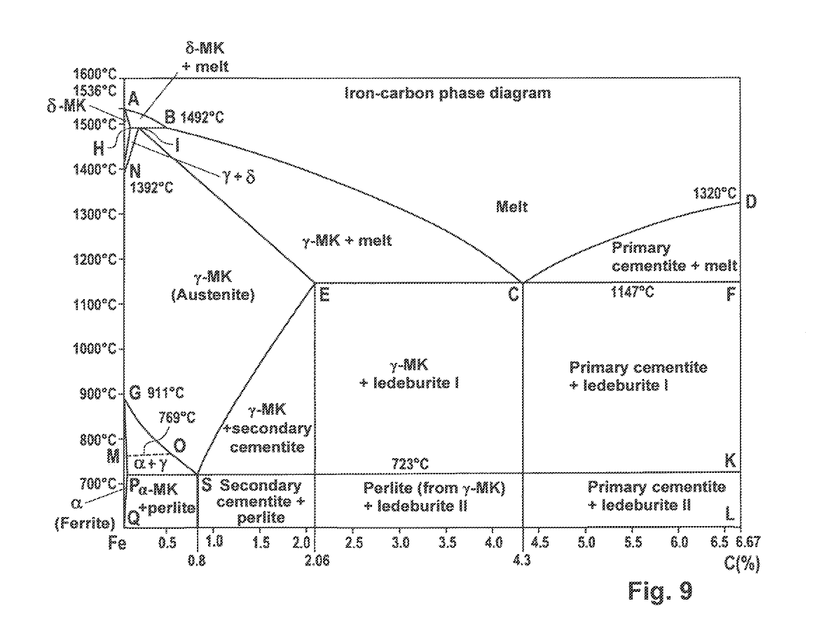

FIG. 9 is an iron-carbon phase diagram for steel,

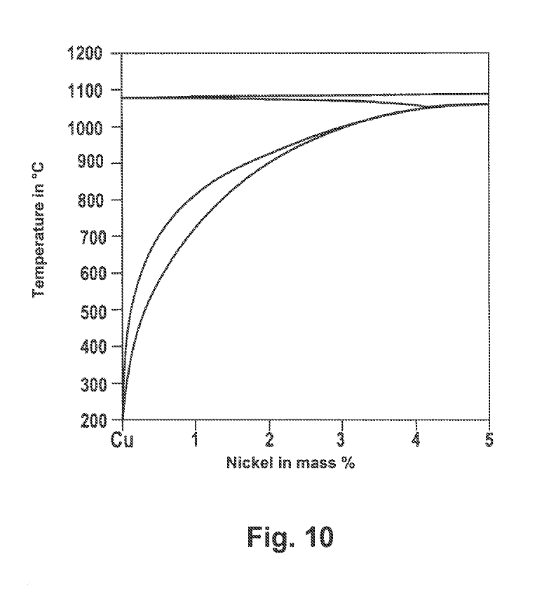

FIG. 10 is the phase diagram for the bearing metal alloy CuNi2Si.

FIG. 2 schematically shows the procedure according to the invention, the temperature T of the individual method steps being plotted against the time t. The sintering is carried out for example at a temperature Tₛ of 940° C. and immediately thereafter the composite material is quenched to a temperature T₁ of approximately 150° C. to 250° C. If two sintering steps are carried out at temperatures Tₛ₁ and Tₛ₂, Tₛ represents the temperature Tₛ₂. The quenching process lasts approximately tₐ=1 to 3 minutes. This is followed by ageing at a temperature T_{A} of from 350° C. to 520° C. The total time duration of the method t_{g2} is thus shorter than the method according to the prior art (see FIG. 1, t_{g1}). The shortening results from full homogenisation annealing (solution annealing) being omitted. In the case of CuNi2Si for example, according to the prior art this in particular requires heating times of several hours to a target temperature of from 750° C. to 800° C. and holding times of several hours, followed by the quenching.

FIG. 3 schematically shows a conveyor system 1. A steel strip roll 3 from which the steel strip material 6 is unwound is located in the unwinding station 2. The strip material 6 is smoothed in a subsequent alignment station 8a.

A powder storage container 10, in which the bearing metal powder 11 is stored and from which the powder 11 is applied to the strip material 6, is located in the subsequent powder spreading unit 9.

In a following first sintering station 13a, the powder 11 is sintered by means of a heating apparatus 14 arranged above the strip material 6. The composite material 25 thus produced is cooled in a cooling station 15 by means of a gas consisting of a nitrogen-hydrogen mixture. The gas mixture is ejected from the spray nozzles 17. The spray nozzles 17 are arranged under the strip material 6, such that the rear face 26 of the composite material 25 can be sprayed with the gas jet 18a consisting of the cooling gas mixture.

The composite material 25 is compressed in the following rolling station 8b and subsequently undergoes a further sintering process in a second sintering station 13b.

The quenching of the composite material 25 is in turn carried out in the quenching station 16, using a nitrogen-hydrogen mixture that is ejected from the spray nozzles 17 of a jet cooler. The spray nozzles 17 are arranged under the strip material 6, such that the rear face 26 of the composite material 25 is sprayed with the gas jet 18b consisting of the quenching medium 18.

The composite material 25 is subsequently wound in a winding station 4. The composite material roll 5 is subsequently transported to an ageing station 24 where the final ageing is carried out in a top hat furnace in order to set the desired mechanical properties of the bearing metal. The ageing time is between 4 hours and 10 hours at temperatures of from 350° C. to 520° C.

The plain-bearing composite material 30 thus produced is then further processed. For example, plain bearing shells can be produced therefrom by means of shaping. FIG. 4a shows a sliding element 40 in the form of a plain bearing shell 42. The plain bearing shell 42 comprises a steel substrate layer 32, a plain-bearing metal layer 34, and a sliding layer 36.

The structure of the valve plate 44 shown in FIG. 4b is that of a steel back 32 and the bearing metal layer 43 produced according to the invention. In the case of applications of this kind, for reasons of stress a sliding layer 36 is generally omitted. The thickness D₁ may be between 1.5 mm and 8 mm. The bearing metal thickness D₂ is 0.5 to 3.0 mm.

### COMPARATIVE EXAMPLE

A plain-bearing composite material consisting of C22+CuNi2Si was produced, the production method according to DE 10 2005 063 324 B4 being carried out as follows:
application of the powder of the bearing metal CuNi2Si
first sintering at Tₛ₁=960° C. for 8 minutes
cooling at a cooling rate of <1 K/s
rolling
second sintering at Tₛ₂=920° C. for 8 minutes
cooling at a cooling rate of <1 K/s

FIG. 5 shows the hardness values of the steel and of the bearing metal following the second sintering.

At the end of the production method, the plain-bearing composite material has a steel hardness of 138 HBW 1/5/30 and a bearing metal hardness of 100 HBW 1/5/30. The corresponding strength values are shown in FIG. 6. The electrical conductivity is given in IACS units.

### EXAMPLES ACCORDING TO THE INVENTION

If higher strengths for both steel and the bearing metal are required for particular applications, i.e. for applications in which wear-resistance and fatigue strength are required primarily, this is achieved using the method according to the invention. The method according to the invention was likewise carried out using the same materials, steel C22 and bearing metal CuNi2Si:
spreading of the bearing metal powder onto a steel strip
first sintering at Tₛ₁=960° C. for 8 minutes
cooling at a cooling rate of <1 K/s
second sintering at Tₛ₂=920′C for 8 minutes
quenching from 920° C. to 200° C., i.e. 720° C. in 0.7 minutes, corresponding to a quenching rate of 20 K/s

Following the second sintering, the steel is quenched and hardened by means of the rapid cooling from the austenite region (see FIG. 9).

Following the rapid setting (see FIG. 10) by means of the high cooling rate, the bearing metal CuNi2Si is present in the form of a supersaturated α-solid solution, has low strengths, and has very high elongation at break values (see FIG. 8, cast state).

The plain-bearing composite material does not subsequently undergo homogenisation annealing, but instead ageing at temperatures of 380° C./8 hours (example 1), 480° C./4 hours (example 2) or 480° C./8 hours (example 3), i.e. ageing in the two-phase region of the CuNi2Si alloy (see FIG. 10), as a result of which nickel silicides form in the α-solid solution, which cause a significant increase in hardness of the bearing metal. The hardnesses of the steel are reduced slightly, but still remain significantly higher than in the comparative example (see FIG. 7).

The corresponding strength values are summarised in FIG. 8.

### LIST OF REFERENCE SIGNS

1 conveyor system
2 unwinding station
3 steel strip roll
4 winding station
5 composite material roll
6 steel strip material
8a alignment station
8b rolling station
9 powder spreading unit
10 powder storage container
11 powder
13a first sintering station
13b second sintering station
14 heating apparatus
15 cooling station
16 quenching station
17 spray nozzle
18 quenching medium
18a gas jet
18b gas jet
24 ageing station
25 composite material
26 rear face of the composite material
30 plain-bearing composite material
32 substrate layer
34 bearing metal layer
36 sliding layer
40 plain bearing element
42 plain bearing shell
44 valve plate
D₁ steel layer thickness
D₂ bearing metal layer thickness
Tₛ sintering temperature
Tₛ₁ sintering temperature
Tₛ₂ sintering temperature
T₁ temperature after quenching
T_{A} ageing temperature
tₛ quenching time
t_{g1} total time of the method according to the prior art
t_{g2} total time of the method according to the invention

1. A method for producing plain-bearing composite materials, in which a powder of a bearing metal is applied to a strip material made of steel, and the bearing metal undergoes at least one sintering process, and the composite material consisting of the strip material and the bearing metal subsequently undergoes heat treatment, the composite material is quenched following the sintering process, and an ageing process subsequently follows.

2. The method according to claim 1, wherein the ageing process is carried out at a temperature of between 350° C. and 520° C. for four to ten hours.

3. The method according to claim 2, wherein the ageing process is carried out at a temperature of between 350° C. and 420° C.

4. The method according to claim 2, wherein the ageing process is carried out at a temperature of between >420° C. and 520° C.

5. The method according to claim 1, wherein an austenitic steel is used as the steel.

6. The method according to claim 5, wherein a steel having a carbon content of from 0.15% to 0.40% is used.

7. The method according to claim 1, wherein a bearing metal consisting of a powder of a copper alloy is applied.

8. The method according to claim 7, wherein the copper alloy is hardenable.

9. The method according to claim 7 wherein the copper alloy consists of a copper-nickel alloy, a copper-iron alloy, a copper-chromium alloy or a copper-zircon alloy.

10. The method according to claim 1, wherein the quenching process begins immediately after the sintering process.

11. The method according to claim 1, wherein the quenching process begins within 15 to 25 seconds following the sintering process.

12. The method according to claim 1, wherein the composite material is quenched to a temperature T₁ of from 150° C. to 250° C.

13. The method according to claim 1, wherein the quenching process is carried out at a quenching rate of from 10 K/s to 30 K/s.

14. The method according to claim 1 the quenching of the copper-nickel alloy is carried out at a quenching rate of from 15 K/s to 25 K/s.

15. The method according to claim 1, wherein the quenching of the copper-iron alloy is carried out at a quenching rate of from 15 K/s to 25 K/s.

16. The method according to claim 1, wherein the quenching of the copper-chromium alloy is carried out at a quenching rate of from 10 K/s to 20 K/s.

17. The method according to claim 1, wherein the quenching of the copper-zircon alloy is carried out at a quenching rate of from 10 K/s to 20 K/s.

18. The method according to claim 1, wherein the quenching is carried out using a quenching medium.

19. The method according to claim 18, wherein a nitrogen-hydrogen gas mixture is used for the quenching.

20. The method according to claim 1, wherein the rear face of the composite material is sprayed with the quenching medium.

21. A plain-bearing composite material comprising a steel substrate layer and a sintered bearing metal layer consisting of a copper alloy, wherein the bearing metal layer has a hardness of from 100 HBW 1/5/30 to 200 HBW 1/5/30.

22. The plain-bearing composite material according to claim 21, wherein the substrate layer has a hardness of from 150 HBW 1/5/30 to 250 HBW 1/5/30.

23. The plain-bearing composite material according to claim 21, wherein the bearing metal layer has a tensile strength of from 380 MPa to 500 MPa.

24. The plain-bearing composite material according to claim 21, wherein the bearing metal layer has a yield strength of from 250 MPa to 450 MPa.

25. The plain-bearing composite material according to claim 21, wherein the copper alloy is a copper-nickel alloy, a copper-iron alloy, a copper-chromium alloy or a copper-zircon alloy.

26. The plain-bearing composite material according to claim 21, wherein the copper-nickel alloy comprises 0.5 to 5 wt. % nickel.

27. The plain-bearing composite material according to claim 21, wherein the copper-iron alloy comprises 1.5 to 3 wt. % iron.

28. The plain-bearing composite material according to claim 21, wherein the copper-chromium alloy comprises 0.2 to 1.5 wt. % chromium.

29. The plain-bearing composite material according to claim 21, wherein the copper-zircon alloy comprises 0.02 to 0.5 wt. % zircon.

30. The plain bearing element comprising a plain-bearing composite material according to claim 21.

31. The plain bearing element according to claim 30, including a sliding layer that is applied to the bearing metal layer.

32. The plain bearing element according to claim 31, wherein the sliding layer consists of a galvanic layer.

33. The plain bearing element according to claim 32, wherein the galvanic layer consists of a tin-copper alloy, a bismuth-copper alloy or of bismuth.

34. The plain bearing element according to claim 32, wherein the sliding layer consists of a plastics layer.

35. The plain bearing element according to claim 32, wherein the sliding layer consists of a layer applied by means of a PVD method.

36. The plain bearing element according to claim 32, wherein the sliding layer consists of a sputter layer.

37. The plain bearing element according to claim 30, wherein the plain bearing element is formed as a plain bearing shell, as a valve plate or as a sliding segment.
